(19) United States
(12) Patent Application Publication
(10) Pub. No.: US 2019/0352952 A1
(43) Pub. Date: Nov. 21, 2019

(54) FURNITURE DRIVE FOR MOVING A MOVABLY MOUNTED FURNITURE PART

(71) Applicant: Julius Blum GmbH, Hoechst (AT)

(72) Inventor: Malte SCHMID, Bodolz (DE)

(21) Appl. No.: 16/526,282

(22) Filed: Jul. 30, 2019

Related U.S. Application Data
(63) Continuation of application No. PCT/AT2018/060015, filed on Jan. 18, 2018.

(30) Foreign Application Priority Data
Jan. 31, 2017 (AT) A 50068/2017

(51) Int. Cl. E05F 1/10; E05D 15/46

(52) U.S. Cl. CPC E05F 1/1041; E05Y 2900/20; E05Y 2600/626; E05D 15/46

(57) ABSTRACT

A furniture drive for moving a movably mounted furniture part relative to a furniture body includes a drive unit to be mounted on or in the furniture body, and at least one movably mounted actuating part for moving the movable furniture part. A mounting stop that can be applied to the furniture body is provided on the drive unit.

### BACKGROUND OF THE INVENTION

The present invention concerns a furniture drive for moving a movably mounted furniture part relative to a furniture body. The furniture drive comprises a drive unit for mounting to or in the furniture body, and at least one movably mounted actuating portion for moving the movable furniture part.

The invention further concerns an article of furniture comprising at least one such furniture drive. Finally, the invention concerns a method for mounting a furniture drive to or in a furniture body.

Furniture drives are already known, which are positioned by means of “ruler and pencil” at or in a furniture body. However, a disadvantage with the known positioning procedure is the fact that that such positioning is only highly inaccurate and is only possible with a high level of complication and effort. A correct mounting position more specifically is a necessary prerequisite so that the furniture part can be moved properly in the mounted state.

DE 20 2013 007 519 U1 discloses, for example, a mounting plate which is adapted for fixing two or more actuating drives with housings of differing designs.

### SUMMARY OF THE INVENTION

It is an object of the invention to eliminate at least one of the above-described disadvantages and to provide a furniture drive which is improved over the state of the art, and an improved article of furniture having at least one furniture drive so as to permit simplified mounting of the furniture drive to or in a furniture body.

A further object of the invention is to provide an improved method for mounting a furniture drive to or in a furniture body in order once again to ensure simplified and in particular standardized mounting.

An essential idea in regard to the furniture drive according to the invention is that at least one mounting abutment configured to bear against the furniture body is provided on the drive unit. By virtue of that measure, the furniture drive can be positioned at a predetermined mounting position on or in a furniture body.

In other words, the furniture drive can have at least one mounting abutment configured to bear against a front face of the furniture body, wherein the drive unit, by virtue of the mounting abutment bearing against the front face of the furniture body, can be positioned at a predetermined mounting position on or in the furniture body. In that respect, the furniture body can have at least one vertically extending side wall, wherein it is preferably provided that the front face of the furniture body is formed by a vertically extending narrow side of that side wall. As an alternative thereto, it can be provided that the end is formed by a horizontally extending narrow side of a top wall of the furniture body.

According to an embodiment, it is provided that the drive unit has a housing and/or a mounting plate and the mounting abutment is in the form of a component separate from the housing and/or from the mounting plate. In that way, a damaged mounting abutment can be easily replaced.

The mounting abutment can be mounted moveably relative to the drive unit. It is preferably provided that the mounting abutment is mounted pivotably and/or displaceably relative to the drive unit between a first position and a second position.

According to a further embodiment, the mounting abutment is pre-fitted to the drive unit, wherein the mounting abutment, in the pre-fitted state, is mounted to the drive unit displaceably and/or pivotably relative to the drive unit.

According to a further embodiment, a cover cap can be provided, wherein the cover cap at least partially covers the mounting abutment in the first position and/or a lateral visible region of the furniture drive in the mounted state. The cover cap can preferably have a curved portion adapted so as to cover the mounting abutment in its first position.

In the case of an article of furniture comprising at least one furniture drive, the article of furniture can have a furniture body and a furniture part, preferably a flap, which is movable upwardly relative to the furniture body. The furniture part is mounted movably by the furniture drive between a closed position and a position of being lifted relative to the furniture body. The movement of the furniture part relative to the furniture body is therefore assisted by the furniture drive, for example by a spring device and/or by an electric drive.

For the sake of simplicity hereinafter, instead of “the housing and/or the mounting plate” of the drive unit, reference is made to a “mounting plate”, in which respect, however, the same details are also applicable to the housing.

### BRIEF DESCRIPTION OF THE DRAWINGS

Further advantages and details of the invention will be apparent from the Figures and the related specific description. In the drawing:

FIGS. 1a, 1b show an article of furniture comprising a furniture body and a movable furniture part, the furniture part being movable by furniture drives,

FIGS. 2a-2c show a wall of a furniture body and a furniture drive in a position which is positioned in respect of height or in respect of height and depth respectively, and an enlarged detail view in relation thereto,

FIGS. 3a, 3b are a perspective view and an enlarged detail view in relation thereto of the furniture drive of FIG. 1a,

FIGS. 4a, 4b are a perspective view and an enlarged detail view in relation thereto of the furniture drive of FIG. 1a,

FIGS. 5a-5c are a perspective view and two enlarged detail views in relation thereto of the furniture drive of FIG. 1a, and

FIGS. 6a-6d show the mounting abutment in different positions.

### DETAILED DESCRIPTION OF THE INVENTION

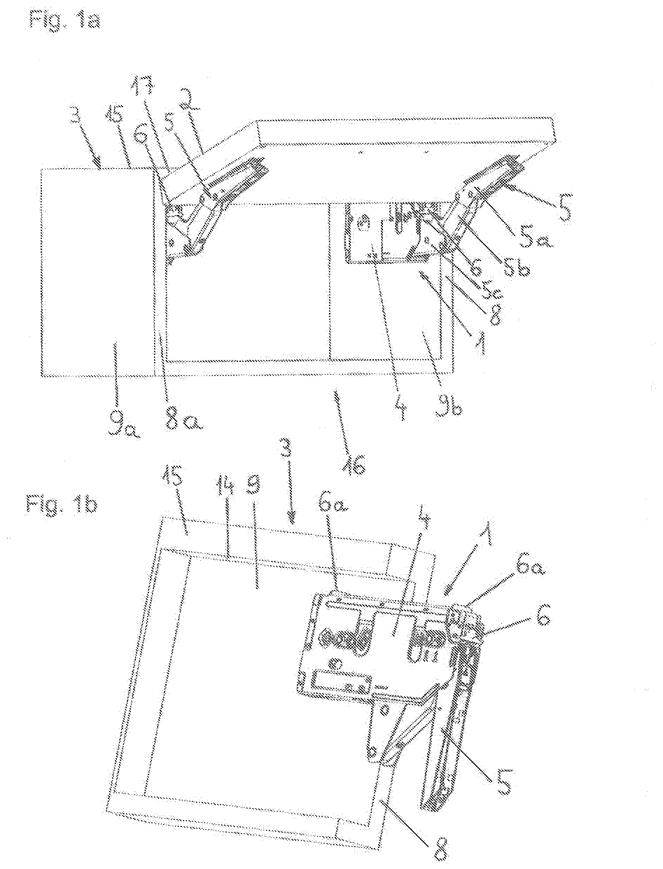

FIG. 1a shows an article of furniture 16 having a furniture body 3 and a furniture part 2 upwardly movable relative to the furniture body 3. The upwardly movable furniture part 2, in this figure, is in the form of a furniture flap. In addition, arranged at the two side walls 9a, 9b is a respective furniture drive 1, wherein the furniture drives 1 respectively have a drive unit 4 and at least one moveably mounted actuating portion 5. The furniture part 2, in this case, is movable by the actuating portions 5 between a closed position and a position of being lifted relative to the furniture body 3. In FIG. 1, the furniture part 2 is shown in a lifted position. The actuating portions 5 can also be of a multi-part structure. The furniture drive 1 arranged at the side wall 9b has, for example, three actuating arms 5a, 5b, 5c hingedly connected to one another. In this connection, it is additionally noted that the actuating portions 5 do not have to be connected directly to the furniture part 2. An indirect connection by way of further levers and/or fitments can also be provided.

FIG. 1b shows a wall 9 and a portion of a top wall 15 of a furniture body 3. The furniture drive 1, in this case, is not yet positioned at a predetermined mounting position. In addition, the furniture drive 1 has a drive unit 4, a movably mounted actuating portion 5, a substantially T-shaped mounting abutment 6 and two abutments 6a. The mounting abutment 6, in this case, is mounted movably relative to the drive unit 4. The two abutments 6a serve for positioning in respect of height of the drive unit 4 in the furniture body 3. The top wall 15 has an underside 14, wherein the abutments 6a can be bear against that underside 14 of the top wall 15.

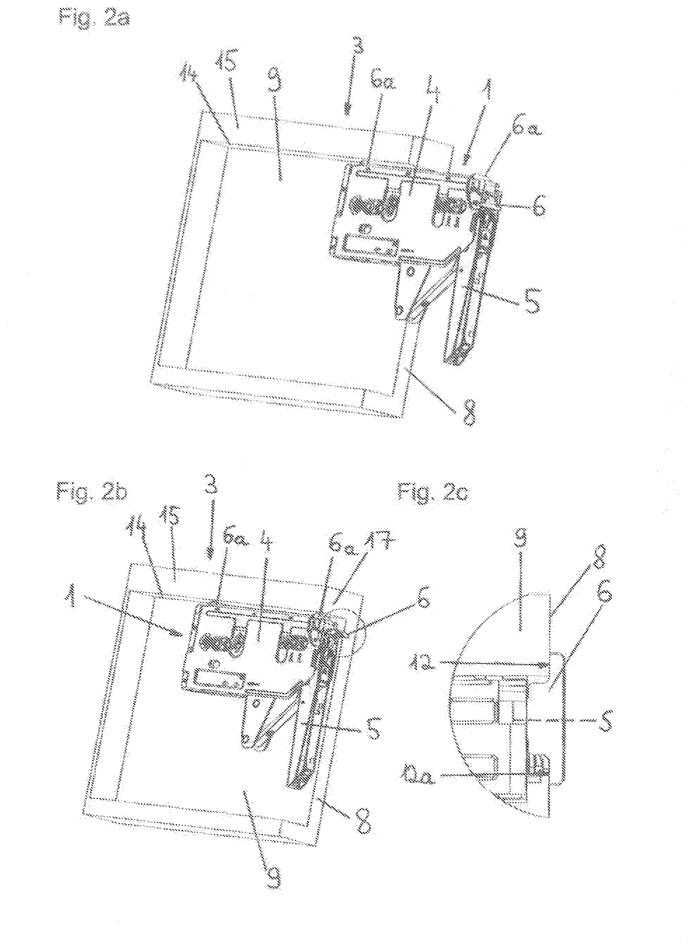

FIG. 2a shows a wall 9 and a portion of a top wall 15 of a furniture body 3. The top wall 15 has an underside 14, and the two abutments 16a can bear against the underside 14. Once again, the furniture drive 1 has a drive unit 4, an actuating portion 5 mounted pivotably relative to the drive unit 4, a mounting abutment 6 and the two above-mentioned abutments 6a. The substantially T-shaped mounting abutment 6 serves for bearing against the front face 8 of the wall 9. As a difference in relation to FIG. 1 b, the abutment 6a shown at the left in the view is bears already against the underside 14 of the top wall 15 and thus the drive unit 4 is pre-positioned in respect of height in the furniture body 3. The abutment 6a shown at the right is subsequently to be bear against the underside 14 of the top wall 15.

FIG. 2b shows the wall 9 and a portion of the top wall 15 of the furniture body 3. The illustrated furniture drive 1 is now positioned at a predetermined mounting position on the wall 9 in the furniture body 3. The two abutments 6a serving for heightwise positioning of the drive unit 4 bear against the underside 14 of the top wall 15. The mounting abutment 6 is applied to the end 8 of the wall 9, so that the drive unit 4 is positioned in respect of depth in the furniture body 3. By virtue of a flat side of the drive unit 4 bearing against the wall 9, therefore the drive unit 4 is fixed in all directions in the furniture body 3 at a predetermined mounting position. In contrast to FIG. 2a, the mounting abutment 6 is shown in a pivoted and displaced position so that the mounting abutment 6 can be applied to the front face 8. As an alternative thereto, it is also possible for the drive unit 4 to be bear with a flat side against the underside 14 of the top wall 15, so that the mounting abutment 6 can be applied to the front face 17 of the top wall 15.

FIG. 2c shows an enlarged view of the region circled in FIG. 2b. In this respect, it can be seen that the mounting abutment 6 has an axis of symmetry S, wherein the mounting abutment 6 is of a structure of mirror-image symmetry with respect to the axis of symmetry S, so that the mounting abutment 6 can be selectively applied by a movement towards the left or towards the right against two different front faces 8, 8a of two mutually opposite side walls 9a, 9b of the furniture body 3. Accordingly, the illustrated furniture drive 1 can be positioned both at left and also at right side walls 9a, 9b of a furniture body 3. In addition, the mounting abutment 6 has the two abutment surfaces 12, 12a arranged symmetrically relative to the axis of symmetry S. In FIG. 2c, the abutment surface 12 is applied against the front face 8.

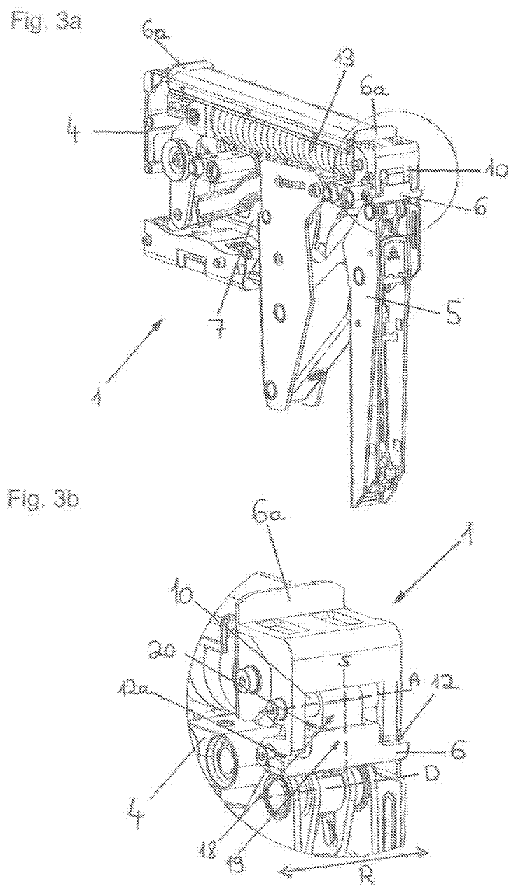

FIG. 3a shows a perspective view of the furniture drive 1, wherein the drive unit 4 includes a mounting abutment 6 mounted movably by a pin 10. In addition, the drive unit 4 has a mounting plate 7 serving for fixing the drive unit 4 to a wall 9. Furthermore, there is provided a spring device 13 for applying a force to the actuating portion 5.

FIG. 3b shows an enlarged view of the region circled in FIG. 3a. In that respect, the two abutment surfaces 12, 12a of the mounting abutment 6 can be clearly seen, wherein those two abutment surfaces 12, 12a serve for bearing against the front faces 8, 8a of two mutually opposing side walls 9a, 9b. It is also possible to see the axis A, about which the mounting abutment 6 is mounted pivotably. The drive unit 4 has a recess 20 for receiving the mounting abutment 6. The mounting abutment 6 has a first leg 18 and a second leg 19. The width of the first leg 18 is less than the width of the recess 20 and the width of the second leg 19 approximately corresponds to the width of the recess 20. Therefore, displacement of the mounting abutment 6 along the pin 10 or along the axis A in the direction R is possible only after an at least partial pivotal movement of the mounting abutment 6 relative to the drive unit 4. The actuating portion 5 (not visible in this Figure) is mounted pivotably relative to the drive unit 4 about the axis of rotation D, wherein the axis of rotation D and the axis A extend substantially parallel to each other. The direction R in which the mounting abutment 6 is displaceable also extends in parallel spaced relationship with the axis of rotation D.

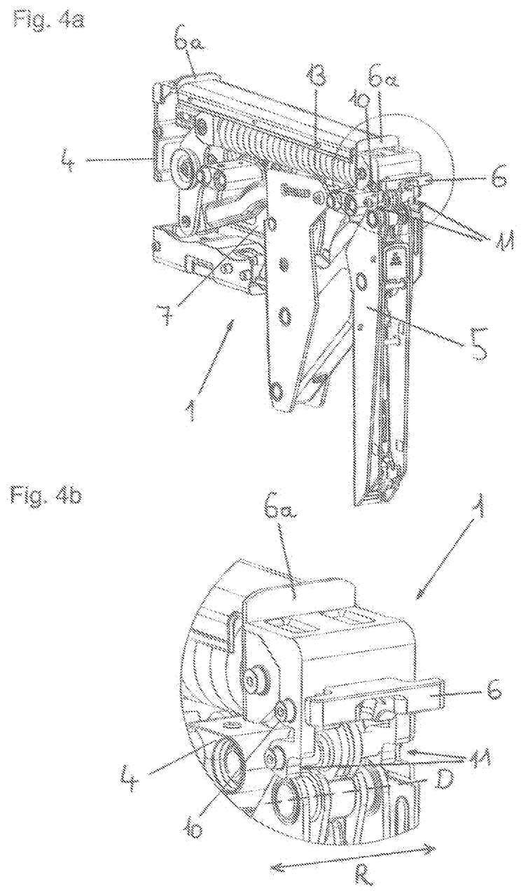

FIG. 4a shows a perspective view of the furniture drive 1. As a difference in relation to FIG. 3a, the mounting abutment 6 is shown in a pivoted position. It is also possible to see the mounting plate 7 which is suitable for fixing the drive unit 4 to a wall 9 by means of screws or dowels (not shown).

FIG. 4b shows a detail view of FIG. 4a. With regard to the axis of rotation D of the actuating portion 5 and the direction R, reference is directed to the description of FIG. 3b. In addition, the recess 11 of the drive unit 4 into which the mounting abutment 6 can be at least partially received in its first position as shown in FIG. 3a is clearly visible.

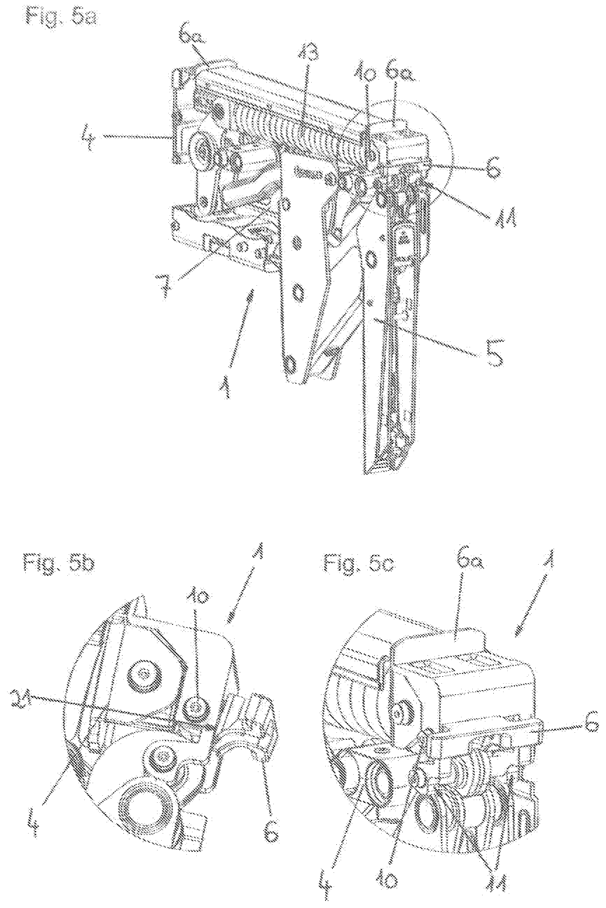

FIG. 5a shows the furniture drive 1 according to FIG. 4a with a further position of the mounting abutment 6 which, in addition to the pivoted position in FIG. 4a, is also displaced towards the left along the pin 10.

FIG. 5b shows another perspective view of the circled region in FIG. 5a. In order for the mounting abutment 6 to be held in the second position in a predetermined location, the mounting abutment 6 has a flattened region 21. A further flattened region 21 is also provided symmetrically relative to the axis of symmetry S on the other side. In that way, the mounting abutment 6 is also held in a predetermined position in the position of being displaced towards the right along the pin 10. The mounting abutment therefore does not drop down under its own weight in the position of being displaced towards the left or towards the right. The references to “up” and “down” respectively refer to the usual mounted position of the furniture drivel.

FIG. 5c shows a further perspective view of the detail region shown in FIG. 5b. In this respect, it is possible to see the recess 11 provided for at least partially receiving the mounting abutment 6 in its first position.

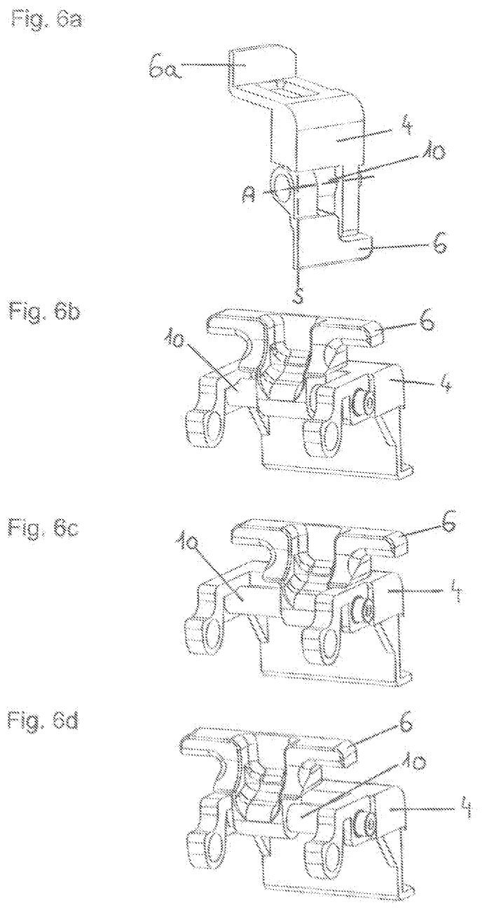

FIG. 6a shows a cross-sectional view of the mounting abutment 6 along the axis of symmetry S of the mounting abutment 6. The mounting abutment 6 is mounted movably by the pin 10 relative to the drive unit 4 and is in the first position in this Figure. It is also possible to see the axis A, about which the mounting abutment 6 is mounted pivotably and is displaceable along that axis A.

FIG. 6b shows the mounting abutment 6, in contrast to FIG. 6a, in a position of being pivoted about the pin 10.

FIGS. 6c and 6d show the mounting abutment 6 in a position of being displaced along the pin 10. That position respectively corresponds to the second position of the mounting abutment 6. Furthermore, that position corresponds to the mounted state of the furniture drive 1, wherein the drive unit 4 of the furniture drive 1 in this position can be positioned both in respect of height and also in respect of depth on or in the furniture body 3. It can also be seen from these two Figures that the flattened region 21 of the mounting abutment 6, shown in FIG. 5b, at least partially bears against the drive unit 4 in the second position and thus the mounting abutment 6 is prevented from dropping down under its own weight.

The method according to the invention for mounting the furniture drive 1 is described with reference to FIGS. 1b, 2a and 2b. In that respect, the following steps are performed:
moving the drive unit 4 into a position until the mounting abutment 6 bears against the front face 8 of the wall 9 of the furniture body 3, so that the drive unit 4 is positioned in respect of depth at a predetermined mounting position in the furniture body 3,
fixing the drive unit 4 at the predetermined mounting position in the furniture body 3, preferably by means of screws or dowels (not shown).

The following step can be provided prior to the movement of the drive unit 4:
pivoting and/or displacing the mounting abutment 6 relative to the drive unit 4 into a second position in which the mounting abutment 6 projects transversely from the drive unit 4, so that the mounting abutment 6 can bear against a front face 8 of the furniture body 3.

In addition, the following step can be performed prior to or after fixing of the drive unit:
pivoting and/or displacing the mounting abutment 6 relative to the drive unit 4 into a first position in which the mounting abutment 6 is at least partially received in a recess 11 of the furniture drive 1.

In that respect, the following step can be performed prior to fixing of the drive unit:
moving the drive unit 4 into a position until at least one of the abutments 6a of the drive unit 4, that are separate from the mounting abutment 6, bears against the underside 14 of the top wall 15 of the furniture body 3, so that the drive unit 4 is positioned in respect of height at a predetermined mounting position in the furniture body 3.

It is noted at this juncture that it is not absolutely necessary for the movement of the drive unit 4 for heightwise position to be carried out prior to the movement of the drive unit 4 for positioning in respect of depth. That can also be carried out in the reverse sequence.

To facilitate the movement of the drive unit 4, the drive unit 4 can bear against the wall 9 of the furniture body 3 during the positioning movement and can be displaced along that wall 9.

### LIST OF REFERENCES

1 furniture drive
2 moveably mounted furniture part
3 furniture body
4 drive unit
5 actuating portion
5a actuating arm
5b actuating arm
5c actuating arm
6 mounting abutment
6a abutment
7 mounting plate
8 front face
8a front face
9 wall
9a, 9b side wall
10 pin
11 recess
12 abutment surface
12a abutment surface
13 spring device
14 underside
15 top wall
16 article of furniture
17 end of the top wall
18 first limb of the mounting abutment
19 second limb of the mounting abutment
20 recess
21 flattened region of the mounting abutment
D axis of rotation
A axis
R direction
S axis of symmetry

1. A furniture drive for moving a movably mounted furniture part relative to a furniture body, comprising:
a drive unit for mounting to or in the furniture body,
at least one movably mounted actuating portion for moving the movable furniture part,
wherein provided at the drive unit is at least one mounting abutment configured to bear against the furniture body, wherein the mounting abutment is pre-fitted to the drive unit,
wherein the mounting abutment, in the pre-fitted state, is mounted pivotably and/or displaceably relative to the drive unit.

2. The furniture drive according to claim 1, wherein the drive unit has a housing and/or a mounting plate, and the mounting abutment is in the form of a component separate from the housing and/or from the mounting plate.

3. The furniture drive according to claim 1, wherein the actuating portion is pivotably mounted relative to the drive unit.

4. The furniture drive according to claim 1, wherein the mounting abutment for positioning at or in the furniture body can be applied to a front face of a wall—preferably a side wall—of the furniture body, wherein the drive unit can be positioned at or in the furniture body at a predetermined mounting position by bearing the mounting abutment against the front face of the wall.

5. The furniture drive according to claim 1, wherein the mounting abutment is displaceable relative to the drive unit only after an at least partially effected pivotal movement.

6. The furniture drive according to claim 1, wherein the mounting abutment is mounted displaceably in a direction extending in parallel spaced relationship with the axis of rotation of the actuating portion.

7. The furniture drive according to claim 1, wherein the mounting abutment is mounted displaceably along a pin.

8. The furniture drive according to claim 1, wherein the actuating portion is mounted pivotably relative to the drive unit about an axis of rotation, wherein the mounting abutment is mounted pivotably about an axis which is preferably parallel to said axis of rotation.

9. The furniture drive according to claim 1, wherein the mounting abutment is mounted limitedly movably between a first position and a second position, wherein the mounting abutment, in the first position, is at least partially received in a recess of the furniture drive, and, in the second position, projects transversely from the drive unit so that the mounting abutment (6) can be applied to a front face of the furniture body.

10. The furniture drive according to claim 9, wherein the mounting abutment includes at least one abutment surface for bearing against the front face of the furniture body.

11. The furniture drive according to claim 10, wherein the mounting abutment includes at least two abutment surfaces configured to alternatively bear against two different front faces of two mutually opposing side walls of the furniture body.

12. The furniture drive according to claim 11, wherein the mounting abutment has an axis of symmetry, wherein the at least two abutment surfaces are arranged in mirror-image symmetrical relationship to the axis of symmetry.

13. The furniture drive according to claim 1, wherein the mounting abutment has a substantially T-shaped configuration.

14. The furniture drive according to claim 1, wherein the furniture drive has at least one spring device for applying a force to the at least one actuating portion.

15. An article of furniture comprising at least one furniture drive according to claim 1.

16. The article of furniture according to claim 15, wherein the article of furniture comprises a furniture body and a furniture part, preferably a flap, upwardly movable relative to the furniture body, wherein the furniture part is mounted movably by the furniture drive between a closed position and a position of being lifted relative to the furniture body.

17. A method of mounting a furniture drive according to claim 1 to a furniture body, the method comprising:
moving a drive unit into a position until a mounting abutment abuts against a front face of a wall—preferably a side wall—of the furniture body, so that the drive unit is positioned in respect of depth at a predetermined mounting position at or in the furniture body,
fixing the drive unit at the predetermined mounting position to or in the furniture body, preferably by means of screws or dowels,
wherein the following step is performed prior to the movement of the drive unit:
pivoting and/or displacing the mounting abutment relative to the drive unit into a second position in which the mounting abutment projects transversely from the drive unit, so that the mounting abutment can bear against a front face of the furniture body.

18. The method according to claim 17, further comprising, prior to or after fixing of the drive unit, pivoting and/or displacing the mounting abutment relative to the drive unit into a first position in which the mounting abutment is at least partially received within a recess of the furniture drive.

19. The method according to claim 17, further comprising, prior to the fixing of the drive unit, moving the drive unit into a position until an abutment of the drive unit, that is preferably separate from the mounting abutment, bears against an underside of a top wall of the furniture body, so that the drive unit is positioned in respect of height at a predetermined mounting position at or in the furniture body.

20. The method according to claim 17, wherein the drive unit bears against a wall—preferably a side wall—of the furniture body during the movement for positioning, and displaced along said wall.
